(19) United States
(12) Patent Application Publication
(10) Pub. No.: US 2017/0102867 A1
(43) Pub. Date: Apr. 13, 2017

(54) Touchpad to interpret palm contact as intentional input

(71) Applicant: Drew Bernard, Albuquerque, NM (US)

(72) Inventor: Drew Bernard, Albuquerque, NM (US)

(21) Appl. No.: 14/882,376

(22) Filed: Oct. 13, 2015

(51) Int. Cl. G06F 3/0488; G06F 3/041

(52) U.S. Cl. CPC G06F 3/04883; G06F 3/0416

(57) ABSTRACT

The present invention is a touchpad that interprets not only non-palm contact, but also palm contact, as intentional input, enabling an efficient functional integration, not previously possible, of a touchpad and a keyboard by interpreting palm contact as the pressing of a virtual key.

### BACKGROUND

Traditional desktop keyboards and graphical pointing devices require moving the hand a long lateral distance between typing and pointing positions. Traditional laptops shorten the distance using a touchpad near the keyboard, but reaching the pointing position still requires lateral movement from the most ergonomic typing position. Additionally, traditional keyboards (both desktop and laptop) require moving the fingers a long distance (lateral or otherwise) between frequently-used letter keys and frequently-used function keys such as the arrow keys. Text editors such as Vi eliminate that finger-movement distance by co-locating letters and functions, but at the cost of separating command and text-insertion modes, which requires the user to switch between the modes and causes user susceptibility to the corresponding mode errors. Text editors such as Emacs in the standard configuration eliminate the finger-movement distance for one hand at a time, but at the cost of requiring repositioning of the fingers of the opposite hand to press modifier keys, resulting in the Emacs-pinky ergonomic problem that's well known to users of that editor. Another mechanism for eliminating the finger-movement distance uses palm keys as modifier keys, but this causes higher cost, complexity, and fragility than for a traditional laptop keyboard and touchpad. None of these attempted solutions to the problem of excessive hand and finger movement is simultaneously user friendly, ergonomic, cost effective, and durable.

### SUMMARY

The present invention is an apparatus a purpose and effect of which is to eliminate the hand-movement lateral distance mentioned in the background of the invention, and eliminate the finger-movement distance without requiring either text-editor modality or use of any fingers to press modifier keys and without causing extra cost, complexity, or fragility. The invention accomplishes this by detecting touch and interpreting both palm and non-palm (e.g. finger or stylus) contact as intentional input, which enables the invention to function both as a virtual palm key and as a traditional touchpad.

### NO DRAWINGS

No drawing is necessary to understand the present invention; the specification herein suffices. The drawable aspects of the present invention (touchpads, keyboards, and palm rests for keyboards) are already well known to laymen. The novel aspect of the present invention is not even amenable to drawing. For these reasons, no drawing is provided.

### DESCRIPTION

### Terms:

In this specification, a palm includes the wrist, and is the part of the body that's traditionally rested, during a pause in typing, on a palm rest that's in front of (or on, or part of) a computer keyboard. A palm key is a keyswitch designed to be pressed using a palm. Traditional devices, positions, functions, methods, and behaviors mentioned herein are all as are well known to laymen, except that the traditional size and position of a palm rest are such that when a user's palms are rested while using the keyboard, only one palm contacts a particular palm rest, such that resting both palms requires two palm rests and the palms contact separate palm rests. An apparatus interprets a particular type of contact as intentional input when it generates a signal indicating the contact and either explicitly indicating that type, or indicating that type only implicitly by explicitly indicating, when contact of any other distinguished type occurs, the type of the latter contact.

### Details:

Historical touchpads commonly failed to distinguish palm contact and non-palm contact. Modern touchpads make the distinction, and interpret non-palm contact as intentional input, but they interpret palm contact only as a state or event to be ignored, typically because the palm contact is an accident or is incidental to the intentional input (the latter being via non-palm contact).

The novelty of the present invention lies in interpretation of palm contact as intentional input distinct from input as which non-palm contact is interpreted; this is the essential aspect that enables the useful effect described above in the summary.

The non-obviousness of the invention is demonstrated by the fact that, despite its significant usefulness, and despite prior touchpads having the capability to distinguish palm and non-palm contact and being modifiable at zero marginal manufacturing cost (via a firmware modification) to become an embodiment of the apparatus of claim #0, none of them has been so modified prior to the present invention.

In one embodiment of the invention, the firmware of the controller of a traditional touchpad that's capable of distinguishing palm and non-palm contact is modified to generate not only a signal when non-palm contact is detected but also a distinct signal specifically indicating palm contact when the latter is detected. In another embodiment, a traditional touchpad that does not interpret contact as palm vs. non-palm, but instead generates uninterpreted images of the touch-sensitive surface with pixels indicating points of contact vs. non-contact, is connected to a host computer that interprets the images as palm vs. non-palm contact and interprets both types of contact as intentional input; in this case, the part (whether hardware or software) of the host computer that interprets the images is part of the apparatus, as is the unmodified traditional touchpad itself.

One skilled in the art will understand that the details of such firmware running on a touchpad controller or software running on a host computer are dependent on the design of the touchpad controller or the design of the host computer and its operating system, and will not need such details in order to understand the present invention. One skilled in the art and familiar with the firmware of a particular traditional touchpad capable of distinguishing palm and non-palm contact will understand that the touchpad can be modified to become an embodiment of the apparatus of claim #0 by modifying the palm-detection function of the firmware such that, upon detection of palm contact, instead of rejecting the contact as invalid input, the function generates a distinct signal, for the duration of the contact, specifically indicating palm contact. Furthermore, he will understand, without needing any further instruction, how to make this modification.

One embodiment of the apparatus of claim #1 is the apparatus of claim #0 such that the palm-contact signal is sent to the keyboard controller in the same way that keypress signals of physical keyswitches of the keyboard are sent to the keyboard controller, and one embodiment of the apparatus of claim #2 is the apparatus of claim #1 such that the palm-contact signal is sent to a particular input of the keyboard controller reserved for signaling presses of a function-plane-switch key. One skilled in the art will not need further instruction to implement these embodiments.

If he is familiar with the firmware of a particular touchpad capable of distinguishing palm and non-palm contact and distinguishing the quantity and locations of palm contacts, he will understand that the touchpad can be modified to become an embodiment of the apparatus of claim #3 by modifying the palm-detection function of the firmware such that, upon detection of a palm contact, movement, or removal event, instead of rejecting the event as invalid input, the function generates a distinct signal specifically indicating the event and the location thereof. Furthermore, he will understand, without needing any further instruction, how to make this modification.

Having understood how to make the apparatuses of claims #0 through #3, he will not need further instruction to make the apparatuses of claims #4 and #5.

Typing on a keyboard with the apparatus of claim #1, with the palms not touching the apparatus, has the same effect as typing on a keyboard that lacks the apparatus. Typing with a palm rested on the apparatus has the effect of typing with the virtual palm key pressed. An advantage over traditional keyboards of a keyboard with this apparatus is that it provides an extra key (or two extra keys, if one apparatus for each palm) that can be pressed without moving the fingers from the home keys (the keys under the resting positions of the fingers), and a further advantage is that the virtual palm key can be easily pressed in combination with any other key, so if the virtual palm key is a modifier key such as shift, chording that modifier with any other key does not require contortion of one hand to reach both keys or replication of the modifier key to both sides of the keyboard to enable two-handed chording to avoid one-handed contortion. A further advantage, not present in either traditional keyboards or any non-traditional keyboard existing prior to the present invention, is that finger input (typically for the traditional functions of a touchpad) can be provided via the same surface (and the same part of that surface) that receives palm input, which eliminates the lateral distance that the hand must travel from the typing position to provide finger input to the touchpad.

The various function keys of a keyboard with the apparatus of claim #2 include ones such as arrow keys, page-up and page-down, home and end, etc, that on traditional keyboards have dedicated physical keys. An advantage of a keyboard with this apparatus is that dedicated keys are not needed for those functions, enabling savings of keyboard cost, size, and weight, yet activating those functions is no more difficult and requires no more finger movement than regular typing of text, because it's just as easy to type with a palm rested as to type with palms not rested; this ease is in contrast to traditional modifier chording methods, in which the fingers must be used to press multiple keys to effect a single function. Another advantage is that frequently-used functions can be placed on the home keys for quick access, without conflicting with the letters that are on the same physical keys. As a result of those advantages, the efficient text editing enabled by co-location of functions and letters does not require use of a modal text editor such as Vi that separates command and text-insertion modes, and does not require use of fingers to press modifier keys.

In the preferred embodiment of the invention, the apparatuses of claims #1 and #2 both occur as part of one keyboard, with each occurrence being a traditional touchpad modified to implement the novelty of the present invention and located in the traditional position of a palm rest, such that the apparatus of claim #1 is on the left and palm contact with it serves as a press of the shift key, and the apparatus of claim #2 is on the right, shift keys and function-plane-switch keys other than the virtual palm keys are omitted from the keyboard because they would be superfluous, finger contact on the touchpads performs traditional touchpad functions, dedicated physical buttons for the touchpads are omitted because such buttons' functions can be performed instead via finger tapping and other gestures on the touchpads, and a touchpad in the centered position such as on a traditional laptop keyboard is omitted because it would be superfluous. Additionally, frequently-used functions are on or near the home keys in the function plane, including the arrow key functions in an inverted-T configuration with the left, down, and right arrows on the home keys under the index, middle, and ring fingers of the right hand (thus co-located with the letters j, k, and l if the Qwerty layout is used).

An alternate embodiment, potentially more expensive to manufacture than the preferred one, is like the preferred one, except that instead of two touchpads (one for each hand) with no touch-sensitive surface between them, the keyboard has one larger apparatus of claim #5, and interprets palm contact on the left side of the touchpad as a press of the shift key, and palm contact on the right side of the touchpad as a press of the function-plane-switch key.

What is claimed is:

0: An apparatus for detecting touch, that distinguishes palm and non-palm contact, interprets both palm and non-palm contact as intentional input, and interprets palm contact as intentional input distinct from input as which non-palm contact is interpreted.

1: The apparatus of claim 0 that's part of (or on, or in front of, or functionally integrated with) a keyboard and located in the traditional position of a palm rest, and interprets palm contact as the pressing of a virtual key, i.e. the functional equivalent of pressing a key (such as a shift key) on the keyboard.

2: The apparatus of claim 1 that interprets the virtual key as a function-plane-switch key, which while pressed, causes physical keys of the keyboard to be interpreted as various function keys rather than as the regular keys (such as for letters and other symbols) as which they're interpreted while the function-plane-switch key is not pressed.

3: The apparatus of claim 0 that distinguishes the quantity and locations of palm contacts and interprets the contacts as input states or events distinguished according to quantity or location.

4: The apparatus of claim 3 that's part of (or on, or in front of, or functionally integrated with) a keyboard and spans the width of the keyboard including the traditional positions of both palm rests, and interprets palm contact as the pressing of a virtual key, such that the particular virtual key pressed depends on the location of the palm contact.

5: The apparatus of claim 4 that interprets one of the virtual keys as a shift key, and another of the virtual keys as a function-plane-switch key.
